(19) United States
(12) Patent Application Publication
(10) Pub. No.: US 2016/0308388 A1
(43) Pub. Date: Oct. 20, 2016

(54) AC/DC Power Converter with Integrated Backup Power Supply for Adjustable Furniture

(71) Applicant: LIMOSS US, LLC, Baldwyn, MS (US)

(72) Inventor: Damon Fisher, Baldwyn, MS (US)

(73) Assignee: LIMOSS US, LLC, Baldway, MS (US)

(21) Appl. No.: 14/688,890

(22) Filed: Apr. 16, 2015

(51) Int. Cl. H02J 9/06; H02M 7/04

(52) U.S. Cl. CPC H02J 9/06; H02M 7/04

(57) ABSTRACT

An AC/DC power converter with integrated backup power supply for adjustable furniture comprising an AC/DC power converter, a charging means, battery, a control system for the adjustable furniture, and appropriate cabling means, where the battery can be wired either as an in-line battery or as a line interactive battery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

1. Field of the Invention

The present disclosure reveals AC/DC power converter with integrated backup power supply for adjustable furniture. Adjustable furniture is frequently used by individuals with disabilities. When the power goes out, these individuals can be trapped in or by this furniture or otherwise, these individuals who need the use of this adjustable furniture would not have access to the adjustable furniture. The present disclosure prevents disabled individuals from being trapped by their furniture or not having the use of their furniture because of lack of power.

2. Background of the Invention

Prior AC/DC power converters for adjustable furniture have been developed but do not reveal a backup power supply integrated into the AC/DC power converter.

In U.S. Pat. No. 8,072,181, Koch discloses a controller for electrically adjustable furniture but does not reveal a backup power supply for the adjustable furniture.

In U.S. Pat. No. 8,926,535, Rawls-Meehan reveals a backup battery for the memory facility of an adjustable bed position control but does not reveal a backup battery integrated into the power supply for the bed.

In U.S. Pat. App. 2003/0030396, Bastholm et al. reveal a power supply for DC motors that reveals that it may be desirable to have battery backup but does not reveal a backup battery integrated into the power supply.

### SUMMARY OF THE INVENTION

An AC/DC power converter with integrated backup power supply for adjustable furniture comprising an AC/DC power converter, a charging means, battery, a control system for the adjustable furniture, and appropriate cabling means. There are two embodiments for the AC/DC power converter with integrated backup power supply. The first embodiment involves the battery being wired as an online battery. The second embodiment involves the battery being wired as a line interactive battery.

In either embodiment of the AC/DC power converter with integrated backup power supply for adjustable furniture, there are three separate embodiments for the charging means. The first embodiment for the charging means is a simple charger where DC power is constantly fed to the battery. The second embodiment for the charging means is an intelligent charger where the intelligent charger can modify the power supplied to the battery based on the detected condition of the battery. The third embodiment for the charging means is a trickle charger, where low current is constantly fed to the battery.

### BRIEF DESCRIPTION OF THE SEVERAL VIEWS OF THE DRAWING

FIG. 1 is a generic depiction of the AC/DC power converter with integrated backup power supply;

FIG. 2 is a wiring diagram of the first embodiment of the AC/DC power converter with integrated backup power supply for adjustable furniture where the battery is wired as an online battery system and a charging means;

FIG. 3A is a wiring diagram of the first embodiment of the AC/DC power converter with integrated backup power supply for adjustable furniture where the battery is wired as an online battery system and the charging means is a simple charger;

FIG. 3B is a wiring diagram of the first embodiment of the AC/DC power converter with integrated backup power supply for adjustable furniture where the battery is wired as an online battery system and the charging means is an intelligent charger;

FIG. 3C is a wiring diagram of the first embodiment of the AC/DC power converter with integrated backup power supply for adjustable furniture where the battery is wired as an online battery and the charging means is a trickle charger;

FIG. 4 is a wiring diagram of the second embodiment of the AC/DC power converter with integrated backup power supply for adjustable furniture where the battery is wired as a line interactive battery and a charging means;

FIG. 5A is a wiring diagram of the second embodiment of the AC/DC power converter with integrated backup power supply for adjustable furniture where the battery is wired as a line interactive battery and the charging means is a simple charger;

FIG. 5B is a wiring diagram of the second embodiment of the AC/DC power converter with integrated backup power supply for adjustable furniture where the battery is wired as a line interactive battery and the charging means is an intelligent charger; and

FIG. 5C is a wiring diagram of the second embodiment of the where the AC/DC power converter with integrated backup power supply for adjustable furniture where the battery is wired as a line interactive battery and the charging means is a trickle charger;

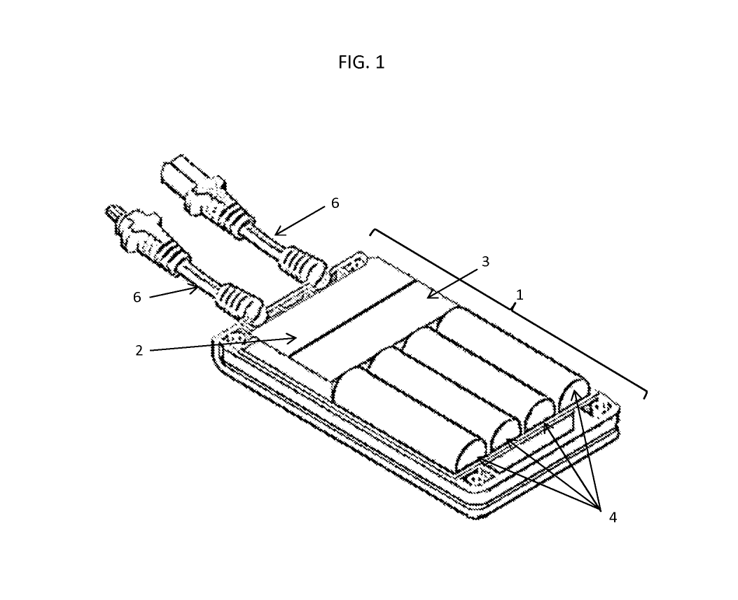

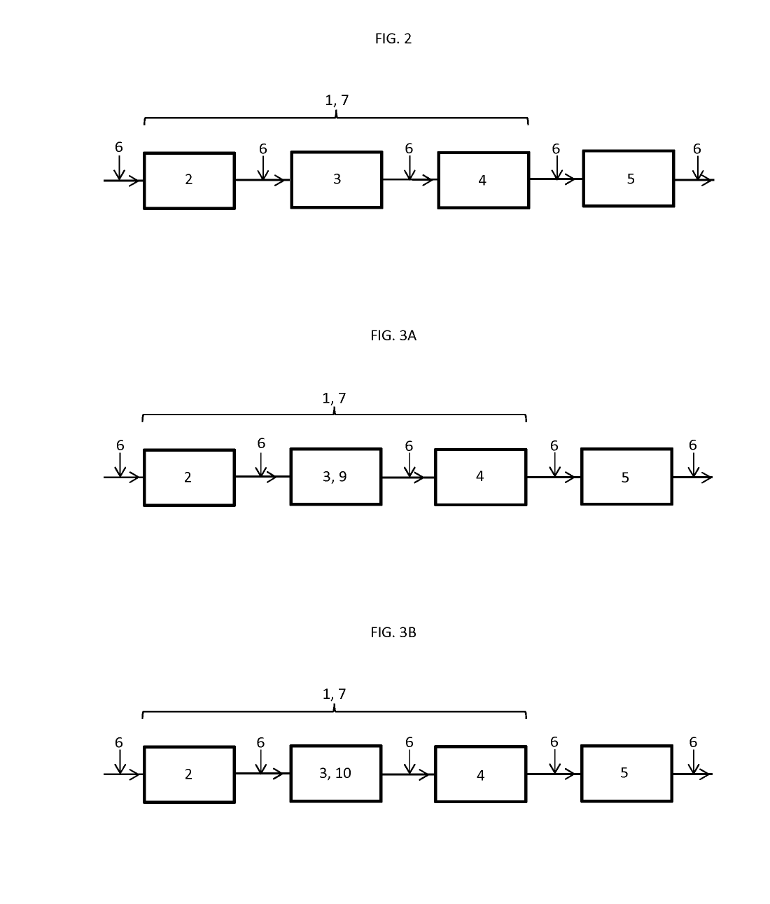

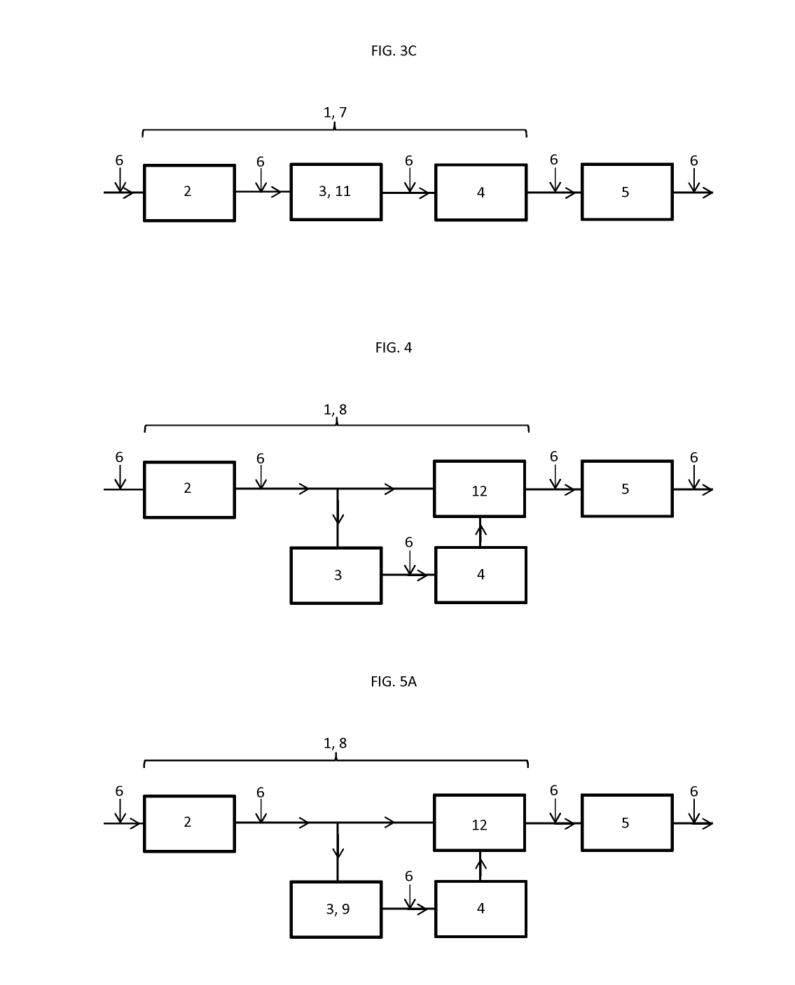

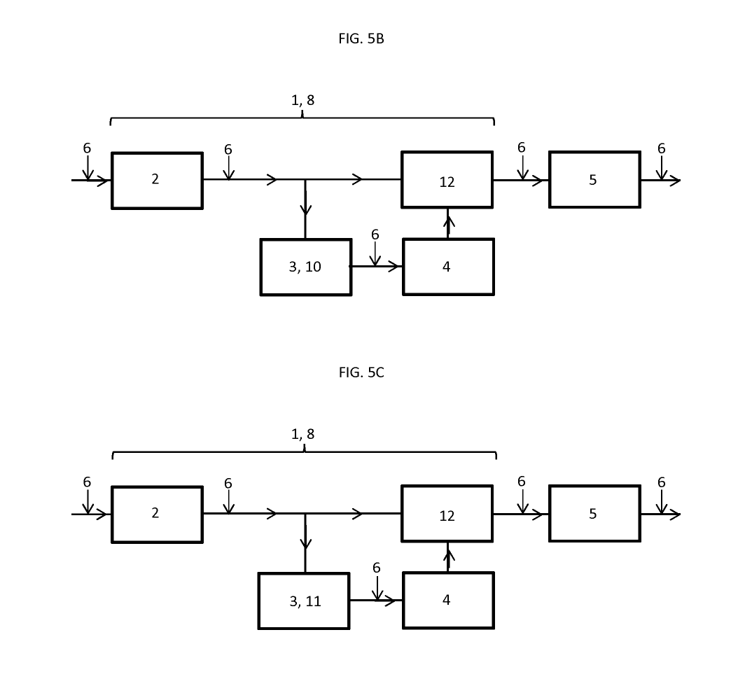

### DETAILED DESCRIPTION OF THE INVENTION

An AC/DC power converter with integrated backup power supply for adjustable furniture 1 comprising an AC/DC power converter 2, a charging means 3, battery 4, a control system for the adjustable furniture 5, and appropriate cabling means 6.

There are two embodiments for the AC/DC power converter with integrated backup power supply. The first embodiment 7 involves the battery being wired as an online battery. The second embodiment 8 involves the battery being wired as a line interactive battery.

In the first embodiment 7, AC power originates from a source, travels along appropriate cabling means 6 and enters the AC/DC power converter 2. Within the AC/DC power converter 2, the incoming AC power is converted to DC power. DC power then exits the AC/DC power converter 2 and flows along the appropriate cabling means 6 to the charging means 3.

From the charging means 3, DC power then flows along appropriate cabling means 6 to the battery 4, and from the battery 4 along the appropriate cabling means 6 to the control system 5 for the adjustable furniture. When DC power is not being supplied from the AC/DC power converter 2 to the control system 5 for the adjustable furniture, DC power is supplied from the battery 4 in order to power the adjustable furniture.

There are three separate embodiments for the charging means 3. The first embodiment for the charging means is a simple charger 9 where DC power is constantly fed to the battery 4. The second embodiment for the charging means is an intelligent charger 10 where the intelligent charger 10 can modify the power supplied to the battery 4 based on the detected condition of the battery 4. The third embodiment for the charging means is a trickle charger 11, where low current is constantly fed to the battery 4.

In the second embodiment 8, the AC power originates from a source, travels along the appropriate cabling means 6 and enters the AC/DC power converter 2. Within the AC/DC power converter 2, the incoming AC power is converted to DC power. DC power then exits the AC/DC power converter 2, travels along the appropriate cabling means 6, where part of said DC power travels directly to a control means 12 along appropriate cabling means 6, while another portion of said DC power travels along appropriate cabling means 6 to the charging means 3 and then from the charging means 3 along appropriate cabling means 6 to the battery 4. The DC power can then flow from the battery 4 along appropriate cabling means 6 to the control means 12. The control means 12 is also connected to the control system 5 for the adjustable furniture.

Said control means 12 allows DC power to flow from the AD/DC power converter 2 to the control system 5 for the adjustable furniture when the control system 5 for the adjustable furniture is activated but, when the control system 5 for the adjustable furniture is activated and no DC power is being supplied from the AC/DC power converter 2, the control means 12 closes the circuit from the battery 4 and DC power flows from the battery 4, through the control means 12, to the control system 5 for the adjustable furniture.

There are three separate embodiments for the charging means 3. The first embodiment for the charging means 3 is a simple charger 9 where DC power is constantly fed to the battery 4. The second embodiment for the charging means 3 is an intelligent charger 10 where the intelligent charger 10 can modify the power supplied to the battery 4 based on the detected condition of the battery 4. The third embodiment for the charging means 3 is a trickle charger 11, where low current is constantly fed to the battery 4.

What is claimed:

1. AC/DC power converter with integrated backup power supply for adjustable furniture comprising:
an AC/DC power converter, a charging means, a battery, the control system for the adjustable furniture, and appropriate cabling means;
where the AC/DC power converter with integrated backup power supply for adjustable furniture where the battery is wired as an online battery;
where AC power originates from a source, travels along appropriate cabling means and enters the AC/DC power converter;
where within the AC/DC power converter, the incoming AC power is converted to DC power;
where DC power exits the AC/DC power converter and flows along the appropriate cabling means to the charging means;
where DC power exits the charging means and flows along the appropriate cabling means to the battery, and from the battery along the appropriate cabling means to the control system for the adjustable furniture; and
where when DC power is not being supplied from the AC/DC power converter to the control system for the adjustable furniture, DC power is supplied from the battery in order to power the adjustable furniture.

2. The AC/DC power converter with integrated backup power supply for adjustable furniture of claim 1 where charging means is a simple charger where DC power is constantly fed to the battery.

3. The AC/DC power converter with integrated backup power supply for adjustable furniture of claim 1 where charging means is an intelligent charger where the intelligent charger can modify the power supplied to the battery based on the detected condition of the battery.

4. The AC/DC power converter with integrated backup power supply for adjustable furniture of claim 1 where charging means is a trickle charger, where low current is constantly fed to the battery.

5. AC/DC power converter with integrated backup power supply for adjustable furniture comprising:
an AC/DC power converter, a charging means, a battery, a control means, the control system for the adjustable furniture, and appropriate cabling means;
where the AC/DC power converter with integrated backup power supply for adjustable furniture is wired with the battery as a line interactive battery;
where AC power originates from a source, travels along the appropriate cabling means and enters the AC/DC power converter;
where within the AC/DC power converter, the incoming AC power is converted to DC power;
where after the power is converted to DC power, DC power exits the AC/DC power converter, travels along the appropriate cabling means, and part of said DC power travels directly to the control means along appropriate cabling means, while another portion of said DC power travels along appropriate cabling means to the charging means and then from the charging means along appropriate cabling means to the battery, and DC power can flow from the battery along appropriate cabling means to the control means;
where the control means is also connected to the control system for the adjustable furniture;
where the control means allows DC power to flow from the AD/DC power converter to the control system for the adjustable furniture when the control system for the adjustable furniture is activated but, when the control system for the adjustable furniture is activated and no DC power is being supplied from the AC/DC power converter, the control means closes the circuit from the battery and DC power flows from the battery, through the control means, to the control system for the adjustable furniture.

6. The AC/DC power converter with integrated backup power supply for adjustable furniture of claim 5 where charging means is a simple charger where DC power is constantly fed to the battery.

7. The AC/DC power converter with integrated backup power supply for adjustable furniture of claim 5 where charging means is an intelligent charger where the intelligent charger can modify the power supplied to the battery based on the detected condition of the battery.

8. The AC/DC power converter with integrated backup power supply for adjustable furniture of claim 5 where charging means is a trickle charger, where low current is constantly fed to the battery.
